(19) United States
(12) Patent Application Publication
(10) Pub. No.: US 2026/0081493 A1
(43) Pub. Date: Mar. 19, 2026

(54) MAGNETIZATION DEVICE

(71) Applicants: HONDA MOTOR CO., LTD., Tokyo (JP); Nihon Denji Sokki Co., Ltd., Tokyo (JP)

(72) Inventors: Haruhiko TAKASAKI, Tokyo (JP); Tsuyoshi IINO, Tokyo (JP); Yuuichi HIRAMATSU, Tokyo (JP)

(21) Appl. No.: 19/329,904

(22) Filed: Sep. 16, 2025

(30) Foreign Application Priority Data
Sep. 19, 2024 (JP) 2024-162299

(51) Int. Cl. H02K 1/28; H02K 1/26

(52) U.S. Cl. CPC H02K 1/28; H02K 1/265

(57) ABSTRACT

The present invention provides a magnetization device capable of suppressing the occurrence of cracks in a resin sealing a coil and improving the effect and efficiency of magnetization, and the magnetization device is to magnetize a magnet disposed on a rotor of a motor, the magnetization device includes a core surrounding a periphery of the rotor, a coil for supplying a magnetic field for magnetizing the magnet of the rotor, a slot portion formed on an inner peripheral side of the core and having an opening for accommodating the coil, a resin for sealing the coil accommodated in the slot portion, and a sealing member provided to close the opening so that the resin is not exposed to the inner peripheral side.

### REFERENCE TO RELATED APPLICATIONS

The present invention relates to and asserts priority from Japanese patent application No. 2024-162299 filed on September 19, 2024, and incorporates the entirety of the contents and subject matter of all the above application herein by reference.

### BACKGROUND OF THE INVENTION

### 1. Technical Field

2. The present invention relates to a magnetization device for magnetizing a magnet disposed on a rotor of a motor.

### Background Art

For manufacturing a brushless motor having a magnet disposed on a rotor of a motor, a magnetization device for magnetizing the magnet to be magnetized disposed on the rotor of the motor has been proposed (see, for example, Patent Document 1: Japanese Patent Application Publication No. 2010-104119 and Patent Document 2: Japanese Patent Application Publication No. 2018-074714).

The magnetization device disclosed in Patent Document 1 includes a magnetization coil for magnetizing the magnet of the rotor wound around a tooth portion protruding from a yoke body.

In the magnetization device disclosed in Patent Document 2, the magnetization coil is inserted in a slot portion as a hole provided in a core member

### SUMMARY OF INVENTION

In the magnetization device disclosed in Patent Document 1 and the magnetization device disclosed in Patent Document 2, the magnetization coil is separated from an outer periphery of the rotor with a predetermined distance, and thus effect and efficiency of the magnetization are reduced due to the distance.

In order to dispose the magnetization coil at a position as close as possible to an inner periphery of the core member, it is conceivable to employ a configuration in which the slot portion has an opening on the inner peripheral side of the core member.

In the case of adopting this configuration, the magnetization coil accomodated in the slot portion is sealed by being solidified with resin, as in the magnetization device disclosed in Patent Document 2.

However, in the case of the slot portion is configured to have the opening on the inner peripheral side of the core member, the thickness of the resin between the magnetization coil and the inner periphery of the magnetization device (core member) is reduced.

Therefore, when a large current with a high voltage for magnetization is applied through the magnetization coil, the resin may be cracked due to vibration of the magnetization coil, heat generation by the current, or the like.

In order to solve the above-described problems, the present invention provides a magnetization device capable of suppressing the occurrence of cracks in the resin sealing a coil and improving the effect and efficiency of magnetization.

A magnetization device of the present invention is a magnetization device that magnetizes the magnet disposed on the rotor of the motor.

The magnetization device of the present invention includes a core surrounding periphery of the rotor, a coil for supplying a magnetic field for magnetizing the magnet of the rotor, a slot portion formed on an inner peripheral side of the core and having an opening for accommodating the coil, a resin for sealing the coil accommodated in the slot portion, and a sealing member provided to close the opening so that the resin is not exposed to the inner peripheral side of the core.

According to the magnetization device of the present invention, the coil accommodated in the slot portion is sealed with the resin, and the sealing member is provided so as to close the opening on the inner peripheral side of the slot portion so that the resin is not exposed to the inner peripheral side. This can suppress the occurrence of cracking in the resin sealing the coil and improve the effect and efficiency of magnetization.

### BRIEF DESCRIPTION OF DRAWINGS

FIG. 1 is a schematic configuration diagram of a magnetization device according to an embodiment of the present invention.

FIG. 2 is a plan view of a core member of the magnetization device of FIG. 1.

FIG. 3 is a diagram showing a laminated structure of the magnetization device of FIG. 1.

FIG. 4 is a diagram showing a laminated structure of the magnetization device of FIG. 1.

FIG. 5 is an enlarged plan view of a part of the core member of FIG. 2.

FIG. 6 is a schematic configuration diagram of a coil of the magnetization device of FIG. 1.

FIG. 7 is an enlarged view of a part of the coil of FIG. 6.

FIGS. 8A and 8B are schematic configuration diagrams of a sealing plate of the magnetization device.

FIG. 9 is an enlarged view of a part of the magnetization device of FIG. 1.

### DESCRIPTION OF EMBODIMENTS

First, an overview of the present invention will be described prior to description of specific embodiments of the present invention.

A magnetization device of the present invention is a magnetization device that magnetizes a magnet disposed on a rotor of a motor.

The magnetization device of the present invention includes a core surrounding the rotor, a coil for supplying a magnetic field for magnetizing the magnet of the rotor, a slot portion formed on an inner peripheral side of the core and having an opening for accommodating the coil, a resin for sealing the coil accommodated in the slot portion, and a sealing member provided to close the opening so that the resin is not exposed to the inner peripheral side.

In the magnetization device of the present invention, the core is disposed outside the rotor and magnetizes the magnet of the rotor from the outside. To that end, the core is configured to surround the rotor, such as in a cylindrical shape.

A soft magnetic material can be used as the material of the core.

The core can be configured with a cylindrical massive core or a laminated core being formed by laminating a plurality of a plate shape core members.

The core has a slot portion that is open on the inner peripheral side.

In the magnetization device of the present invention, the coil supplies a magnetic field for magnetizing the magnet of the rotor, and is formed by winding an electric wire.

A wire material having high conductivity such as a copper wire is used for an electric wire configuring the coil.

The coil is accommodated in the slot portion formed in the core.

The coil accommodated in the slot portion is sealed with resin.

In addition, when the cross-sectional shape of the electric wire configuring the coil is a substantially quadrangular shape, the electric wire can be wound in a state of being in close contact from each other as compared with an electric wire having a substantially circular cross-sectional shape. Accordingly, the entire electric wire of the coil can be brought close to the rotor side, and the magnetic field supplied to the rotor can be strengthened.

In the magnetization device of the present invention, the sealing member closes the opening on the inner peripheral side of the slot portion so that the resin sealing the coil is not exposed to the inner peripheral side.

When the sealing member is formed of a nonmagnetic metal such as stainless steel, the sealing member has good heat resistance.

The sealing member is fixed to the core, but in order to provide resistance to vibration and heat generation when a current is applied through the coil, it is desirable to fix the sealing member to the core by fitting the sealing member into a recess or the like provided in the core, rather than by adhesion with an adhesive.

According to the magnetization device of the present invention, the sealing member is provided to close the opening on the inner peripheral side of the slot portion so that the resin sealing the coil accommodated in the slot portion is not exposed to the inner peripheral side. This can suppress the occurrence of cracking in the resin sealing the coil and improve the effect and efficiency of magnetization.

Next, a specific embodiment of the present invention will be described.

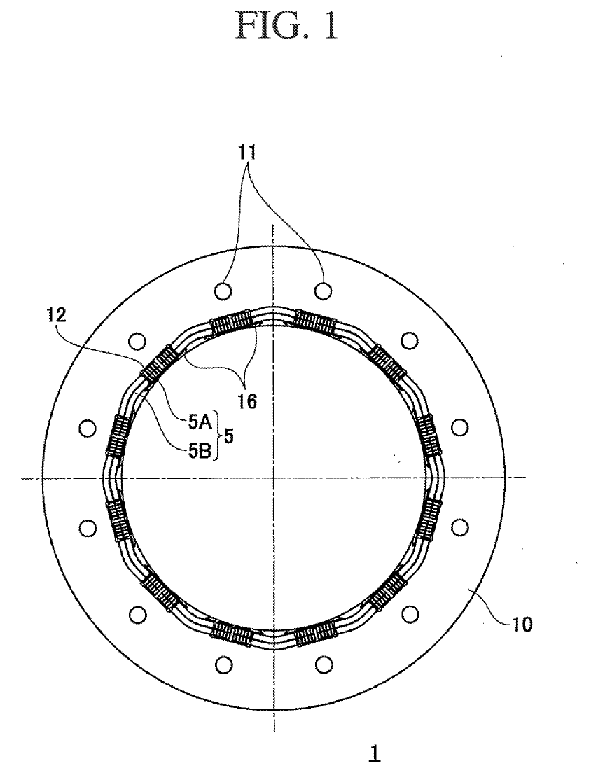

FIG. 1 is a schematic configuration diagram of the magnetization device according to the embodiment of the present invention.

FIG. 1 is a plan view of a core member 10 configuring the magnetization device 1, with a coil 5 and a sealing plate 16 attached thereto.

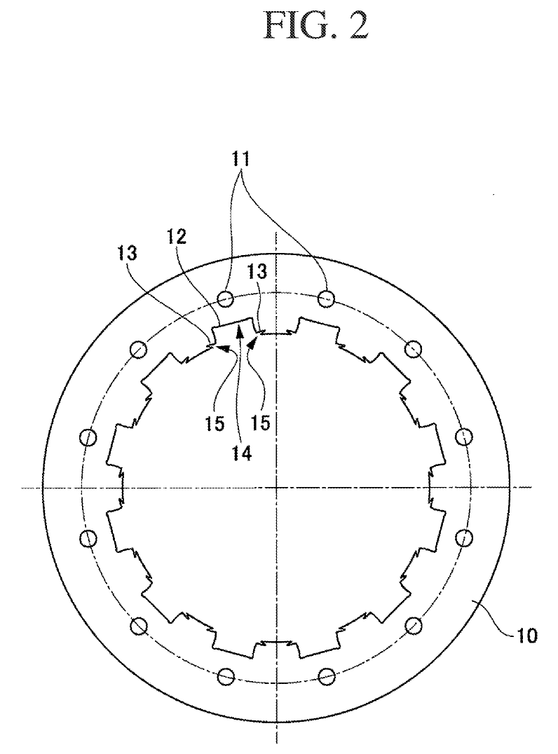

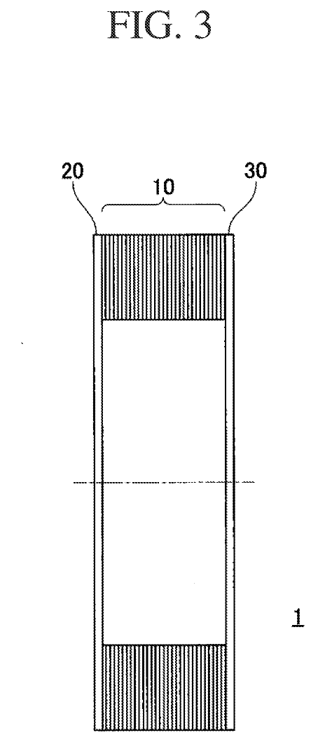

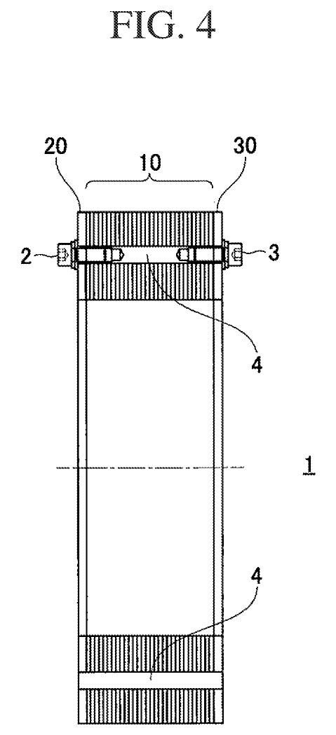

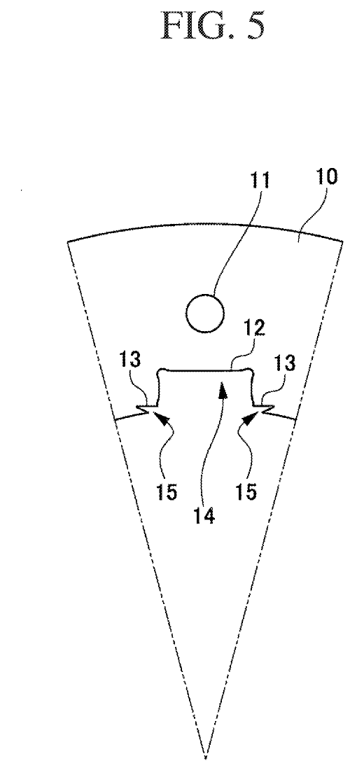

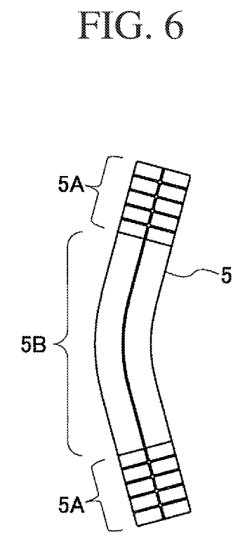

Further, a plan view of the core member 10 of the magnetization device 1 of FIG. 1 is shown in FIG. 2, a laminated structure of the magnetization device 1 is shown in FIGS. 3 and 4, an enlarged view of a part of the core member 10 is shown in FIG. 5, and a schematic configuration diagram of the coil 5 of the magnetization device 1 is shown in FIG. 6.

As shown in FIGS. 1 and 2, the core member 10 configuring the magnetization device 1 has a substantially concentric planar shape. Then, the rotor to be magnetized by the magnetization device 1 is inserted into a space inside the inner periphery of the core member 10. A bolt hole 11 is formed at an intermediate position between the inner periphery and the outer periphery of the core member 10. The core member 10 is formed of a soft magnetic material, for example, a plate-shaped electromagnetic steel plate (silicon steel or the like).

As shown in FIGS. 3 and 4, a large number of plate-shaped core members 10 are laminated, and the laminated core is sandwiched between an upper member 20 and a lower member 30 and fixed by bolt 2 and bolt 3, thereby forming the core having a cylindrical shape. FIG. 3 shows a cross-sectional view of a portion of the laminated core that does not include the bolt hole 11. FIG. 4 shows a cross-sectional view of a portion of the laminated core including the bolt holes 11.

As shown in FIG. 4, the bolt 2 and the bolt 3 are inserted into the space 4 formed by the bolt holes 11 of the core members 10. In addition, a thread (not shown) for screwing the bolt 2 and the bolt 3 is formed in the bolt hole 11 of each core member 10.

The rotor to be magnetized by the magnetization device 1 is disposed inside the inner periphery of the core having a cylindrical shape in the magnetization device 1

As shown in the enlarged view in FIG. 5, a recess 12 and a recess 13 are formed on the inner periphery of the core member 10. The recess 12 has a shape in which a side of a rectangle is curved. The recess 13 has a shape like two sides of a triangle.

The recess 12 forms the slot portion 14 for accommodating the coil in the space inside the recess 12. The slot portion of the configuration of Patent Document 2 has a configuration in which the inner peripheral side is closed, whereas the slot portion 14 of the magnetization device 1 of the present embodiment has a configuration in which the inner peripheral side is open.

A tip ends 16B of the sealing plate 16, which will be described in detail later, is inserted into the recess 13.

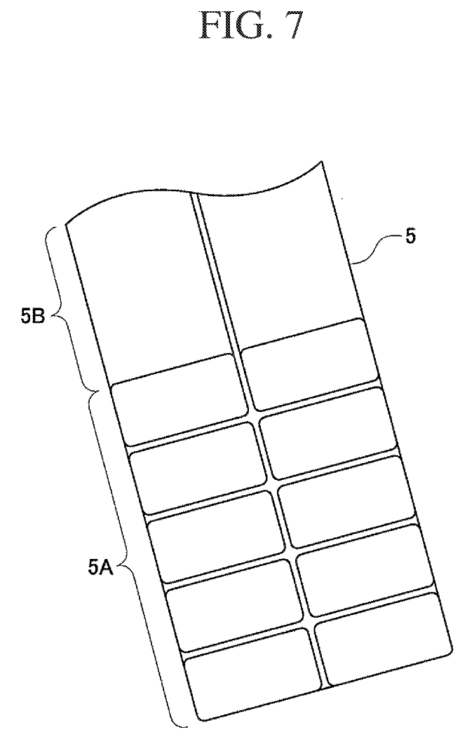

Although not shown, the coil 5 is wound in a substantially rectangular planar shape. The schematic configuration diagram in FIG. 6 is a schematic diagram of the coil 5 wound in the substantially rectangular planar shape as viewed from the short side of the rectangle. FIG. 7 is an enlarged view of a part of FIG. 6.

As shown in the schematic configuration diagram in FIG. 6, the coil 5 has a long side part 5A of the rectangle extending in a direction perpendicular to the paper surface of FIG. 6 and a short side part 5B of the rectangle extending in a direction parallel to the paper surface of FIG. 6.

As shown in FIGS. 6 and 7, the coil 5 is formed of an electric wire having a substantially rectangular cross-sectional shape, and the electric wire is wound in two layers. As shown in FIG. 6, the short side part 5B of the coil 5 is bent symmetrically with respect to the center.

Although not shown in FIGS. 6 and 7, the electric wires extend from both ends of the wound coil 5 to supply a current through the coil 5, and the electric wires extending from both ends are electrically connected to a power supply or the like that supplies the current.

As can be seen from FIGS. 1, 5, and 6, the long side part 5A of the coils 5 are accommodated in the slot portions 14, and the short side part 5B of the coils 5 are attached to portions (so-called tooth portions) of the core member 10 between the slot portions 14. Thus, the coil 5 is attached so as to wind around the tooth portion of the core member 10.

As can be seen from FIGS. 1 and 6, the short side part 5B of the coil 5 having the bent shape is attached to the core member 10 so that the outer peripheral side of the core member 10 is convex.

The coil attached to the core member 10 is sealed with resin (not shown) supplied to the space of the slot portion 14.

In the magnetization device 1 of the present embodiment, in particular, has the opening on the inner peripheral side of the slot portion 14, wherein the sealing plate 16 is provided in inner peripheral side of the slot portion 14 as a sealing member that closes the opening of the slot portion 14 in which the coil 5 is sealed with resin.

The sealing plate 16 is more preferably formed of a nonmagnetic material (for example, a nonmagnetic metal such as stainless steel).

By using the nonmagnetic material for the sealing plate 16, the sealing plate 16 does not affect the magnetic field from the coil 5. In particular, by using the nonmagnetic metal for the sealing plate 16, the sealing plate 16 is less likely to deteriorate due to heat generated during use of the magnetization device 1.

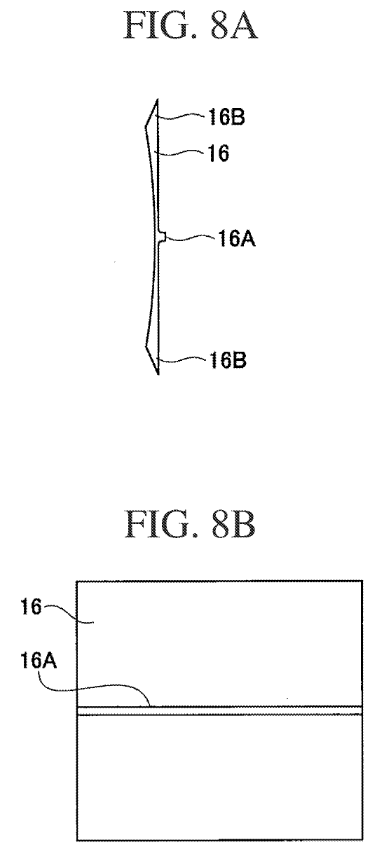

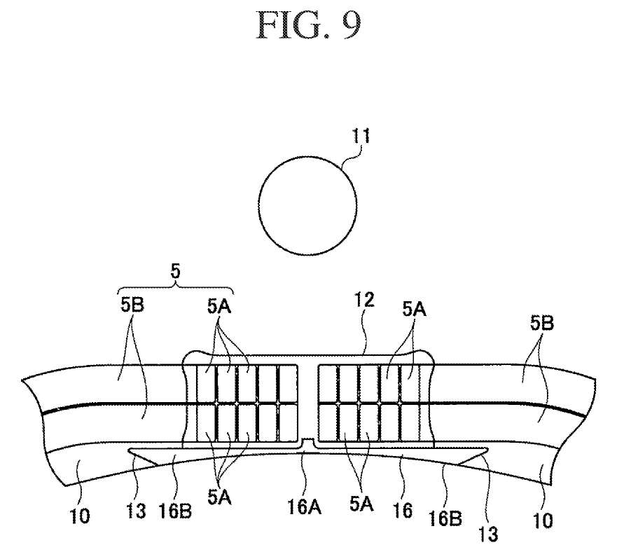

Schematic configuration diagrams of the sealing plate 16 of the magnetization device 1 are shown in FIGS. 8A and 8B, and an enlarged view of a part (a portion near the sealing plate 16) of the magnetization device 1 of FIG. 1 is shown in FIG. 9.

FIG. 8A shows a side view of the sealing plate 16 and FIG. 8B shows a plan view of the sealing plate 16.

As shown in the FIGS. 8A and 8B, the sealing plate 16 has a protrusion 16A protruding to the right side in FIG. 8A in the vicinity of the center line of the plan view shape, and has tips 16B pointed with an acute angle at the upper and lower ends of the drawing. In addition, in the sealing plate 16, a main surface on a side where the protrusion 16A is formed is a flat surface, and a main surface on a side opposite to the protrusion 16A is a curved surface.

As shown in FIGS. 1 and 9, the protrusion 16A of the sealing plate 16 is disposed on the outer peripheral side of the core member 10, and presses and fixes the long side part 5A of the coil 5 in the slot portion 14.

The main surface of the sealing plate 16 on the side opposite to the protrusion 16A is disposed on the inner peripheral side of the core member 10 and faces the rotor.

As shown in FIGS. 1 and 9, the the tips 16B of the sealing plate 16 is fitted into the recess 13 of the core member 10. As a result, the sealing plate 16 is fixed to the inner peripheral side of the slot portion 14.

The thickness of the sealing plate 16 is selected within a range in which the sealing plate 16 has a strength to the extent that the sealing plate 16 is not damaged by a temperature change during use of the magnetization device 1 and the rotor is not too far away from the coil 5 to avoid decrease of the effect and efficiency of magnetization.

According to the configuration of the magnetization device 1 of the present embodiment, the long side part 5A of the coil 5 is accommodated in the space of the slot portion 14 which is formed by the recess 12 of the core member 10 and is open on the inner peripheral side of the core member 10.

Accordingly, compared to the configuration of the magnetization device of Patent Document 1 or Patent Document 2, the coil 5 can be brought closer to the rotor to be magnetized, which is disposed inside the inner circumference of the magnetization device 1, and thus the effect and efficiency of the magnetization of the rotor can be improved.

Further, according to the configuration of the magnetization device 1 of the present embodiment, since the sealing plate 16 is provided on the inner peripheral side of the slot portion 14, the sealing plate 16 can prevent the occurrence of cracking of the resins sealing the long side part 5A of the coil 5 when the current is supplied through the magnetization device 1.

### (Modified Example)

In the magnetization device 1 of the above-described embodiment, the plate-shaped sealing plate 16 is used as a sealing member that closes the opening of the slot portion 14. In the magnetization device of the present invention, the sealing member for closing the opening of the slot portion is not limited to the plate-shaped sealing plate, and sealing members having other shapes can also be used.

The material of the sealing member is not limited to the nonmagnetic metal, and other nonmagnetic materials and magnetic materials can also be used. However, when a magnetic material is used, the material, dimensions, and shape are selected so as not to cause a problem in the strength and shape of the magnetic field supplied from the coil to the magnet of the rotor.

The cross-sectional shape of the electric wire configuring the coil is not limited to the substantially quadrangular cross-sectional shape of the coil 5 of the magnetization device 1 of the above-described embodiment, and may be a cross-sectional shape of another shape (for example, a substantially circular shape or a substantially elliptical shape).

When an electric wire having a substantially rectangular cross-sectional shape is used as in the coil 5 of the magnetization device 1 of the above-described embodiment, the electric wire can be wound in a state of being in close contact from each other, as compared with an electric wire having a substantially circular cross-sectional shape. This brings about advantages such as the fact that the entire electric wire of the coil can be brought closer to the rotor side, and the magnetic field supplied to the rotor can be strengthened.

In the magnetization device 1 of the above-described embodiment, the laminated core is formed by laminating a large number of (a plurality of) flat plate-shaped core members 10, however, the magnetization device of the present invention may employ other configurations (for example, one cylindrical core).

In the case of the configuration in which a large number of flat plate-shaped core members are laminated as in the magnetization device 1 of the above-described embodiment, since one core member is thin, there is an advantage that the recess for forming the slot portion and the recess for inserting a tip end portion of a sealing plate can be easily formed.

The present invention is not limited to the above-described embodiment and modifications, and includes various modifications. For example, the embodiments and the modifications described above are described in detail for easy understanding of the present invention, and the present invention is not necessarily limited to those including all the configurations described above.

1 magnetization device, 2, 3 bolt, 5 coil, 10 core member, 11 bolt hole, 12,13 recess, 14 slot portion, 16 sealing plate, 20 upper member, 30 lower member

What is claimed is:

1. A magnetization device for magnetizing a magnet disposed on a rotor of a motor, the magnetization device comprising:
a core surrounding a periphery of the rotor;
a coil for supplying a magnetic field for magnetizing the magnet of the rotor;
a slot portion formed on an inner peripheral side of the core and having an opening for accommodating the coil;
a resin sealing the coil accommodated in the slot portion;
a sealing member provided to close the opening so that the resin is not exposed to the inner peripheral side.

2. The magnetization device according to claim 1, wherein the sealing member is formed of a nonmagnetic material.

3. The magnetization device according to claim 1, wherein the sealing member is formed of a nonmagnetic metal.

4. The magnetization device according to claim 1, wherein the sealing member is plate-shaped and has a curved surface formed on a side facing the rotor.

5. The magnetization device according to claim 1, wherein the sealing member has a protrusion formed on a side facing the coil.

6. The magnetization device according to claim 1, wherein the core has a recess into which the sealing member is fitted.
